(19) United States
(12) Patent Application Publication
(10) Pub. No.: US 2006/0098971 A1
(43) Pub. Date: May 11, 2006

(54) Lens drive mechanism

(75) Inventor: Atsushi Fuchimukai, Tochigi (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/269,833

(22) Filed: Nov. 9, 2005

(30) Foreign Application Priority Data
Nov. 10, 2004 (JP) P2004-326564

(51) Int. Cl. G03B 3/00

(52) U.S. Cl. 396/144

(57) ABSTRACT

A lens-drive mechanism for a camera is provided that includes a drive source, an output shaft, and a detector. The output shaft has a joint which is connected to a lens barrel attached to a camera body. The output shaft is rotated by a driving force from the drive source and transmits the rotation to the lens barrel through the joint. The detector has a rotating disk that rotates together with the output shaft. The detector detects rotation of the output shaft by detecting rotation of the rotating disk. The rotating disk is so arranged that a rotational axis of the rotating disk substantially coincides with a rotational axis of the output shaft.

### BACKGROUND OF THE INVENTION

1. Field of the Invention

The present invention relates to a lens drive mechanism for an interchangeable lens of an AF camera.

2. Description of the Related Art

Lens-drive mechanisms provided on a body of a camera having interchangeable lenses, are known. The lens drive mechanism is provided with an AF motor, an output shaft, a power transmission system, a pulser (rotating disk), and an encoder. The output shaft engages with a lens barrel when the AF motor and the lens barrel are mounted on the camera body, and transmits the drive force (torque) of the AF motor to the lens barrel. The power transmission system connects the AF motor to the output shaft, so that the rotation of the AF motor is reduced and transmitted to the output shaft. The pulser rotates with the output shaft. The encoder includes a photointerrupter that detects the rotation of the pulser. Further, the power transmission system is equipped with a torque limiting mechanism that limits torque output from the output shaft (refer to the Japanese Unexamined Patent Publication No. 01-304415).

The precise control of the rotation of the output shaft can be achieved by directly controlling the rotation of the AF motor. However, the rotation of the output shaft cannot be precisely controlled, since there is a difference between the rotational speed of the output shaft and the AF motor, which is induced by the torque limiting mechanism interposed between the AF motor and the output shaft.

Therefore, it is preferable to detect the rotation of the output shaft directly. However, since the rotation of the output shaft is slow, the rotation of the output shaft cannot be precisely controlled by directly detecting its rotation. Thus, the rotational speed of the output shaft to which rotational force is transmitted from the AF motor, is increased through a gear, and in turn the rotation is detected by the photointerrupter (sensor) in order to control the rotation of the output shaft.

However, as for a conventional lens-drive mechanism, the pulser cannot be arranged on a side of the output shaft because of interference with the output shaft, so that the pulser should be arranged on a side parallel to the output shaft. Therefore, the rotating axes of the pulser and the output shaft are distant from each other, and thus the dimensions of the conventional lens-drive mechanism in a direction perpendicular to the rotational axis of the output shaft (a radial direction of the pulser) is large.

Thereby, in the Japanese Unexamined Patent Publication No. 01-304415, the pulser having a small diameter is adopted to reduce the size in the direction perpendicular to the rotational axis of the output shaft. However, this reduces the number of pulses output from the photointerrupter per a rotation of the pulser, so that the rotation of the output shaft cannot be precisely controlled.

Further, it can also be contemplated to arrange gears around the output shaft in order to reduce the dimension in the direction perpendicular to the rotational axis of the output shaft. Namely, the rotational axes of the output shaft, the gear wheel, and the pulser are so arranged as to form the vertices of a triangle, when they are viewed from the front side of the output shaft in a direction along the rotational axis of the output shaft. However, this arrangement requires a lot of space (area) for the output shaft, the gear, and the pulser.

Accordingly, there are still the problems of enlarging the size of the lens-drive mechanism, so that the conventional configurations still have disadvantages in reducing the size of the camera.

Further, in order to control the output shaft rotation more accurately than it is in the lens-drive mechanism in the Japanese Unexamined Patent Publication No. 01-304415, it is effective to increase the rotational speed of the output shaft by using a gear train.

However, the arrangement of a plurality of gears requires further space and expands the size of the lens-drive mechanism, thus the size of the camera.

### SUMMARY OF THE INVENTION

An object of the present invention is to provide a lens-drive mechanism that can be downsized.

According to the present invention, a lens-drive mechanism for a camera is provided. The lens-drive mechanism includes a drive source, an output shaft, and a detector.

The output shaft has a joint which is connected to a lens barrel that is attached to a camera body. The output shaft is rotated by a driving force from the drive source and transmits the rotation to the lens barrel through the joint. The detector has a rotating disk that rotates together with the output shaft. The detector detects rotation of the output shaft by detecting rotation of the rotating disk. The rotating disk is so arranged that a rotational axis of the rotating disk substantially coincides with a rotational axis of the output shaft.

### BRIEF DESCRIPTION OF THE DRAWINGS

The objects and advantages of the present invention will be better understood from the following description, with reference to the accompanying drawings in which:

FIG. 1 is a front view of a camera body of a single-lens reflex camera having interchangeable lenses to which an embodiment of a lens-drive mechanism of the present invention is applied;

FIG. 2 is a front view of the camera that illustrates the inner configuration of the camera body shown in FIG. 1.;

FIG. 3 is a perspective view of the lens drive mechanism of the present embodiment of the invention;

FIG. 4 is an exploded perspective view of the lens drive mechanism of the present embodiment;

FIG. 5 is a sectional view of the lens drive mechanism of the present embodiment; and

FIG. 6 is a rear view showing an assembly arrangement of a worm wheel and a clutch spring, where components other than the worm wheel and the clutch spring are removed so as to make the arrangement clearly understood.

### DESCRIPTION OF THE PREFERRED EMBODIMENTS

The present invention is described below with reference to the embodiments shown in the drawings.

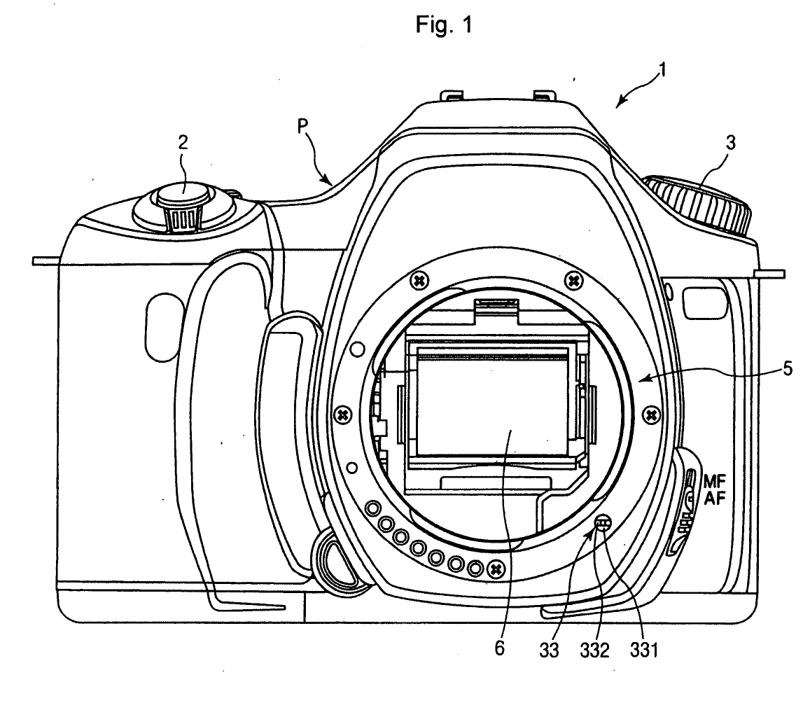

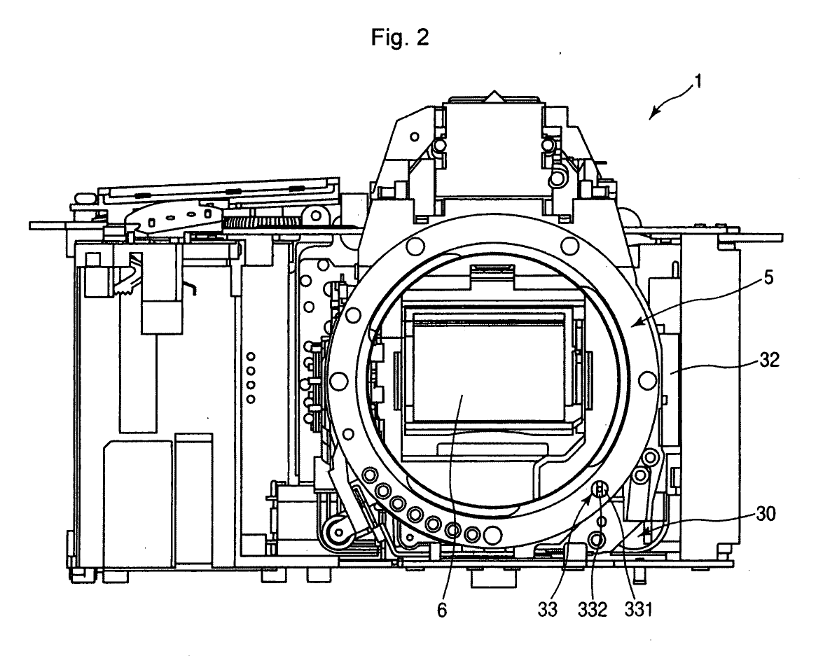

FIG. 1 is a front view of a body of a lens interchangeable single-lens reflex camera to which an embodiment of a lens-drive mechanism (an AF lens-drive block) of the present invention is applied. FIG. 2 is a front view of the camera that illustrates the inner configuration of the camera body shown in FIG. 1.

The camera body 1 illustrated in FIGS. 1 and 2 is a lens interchangeable single-lens reflex camera where a lens barrel (a photographing lens), which can be detachably mounted on the camera body 1, is removed.

As shown in FIG. 1, on an upper surface “P” of the camera body 1, a release button 2 is provided at about the left edge (in FIG. 1) and a mode dial 3 for selecting a mode from various modes is provided at about the right edge (in FIG. 1).

Further, a lens mount 5 for detachably attaching a lens barrel is provided in the middle of the front face of the camera body 1.

In side the camera body 1, a quick return mirror 6 which is arranged on an optical axis of the lens barrel when a lens barrel is mounted, an imaging unit including a CCD (imaging device; not shown), and a shutter unit (not shown) arranged on a light receiving surface side of the imaging unit, are provided.

The camera body 1 further includes a controller (not shown) that integrally controls the camera body 1 and the lens barrel, an AF sensor (not shown), and a lens-drive mechanism 30 for driving the lens barrel, which is mounted on the camera body 1.

The lens-drive mechanism 30 includes an AF motor 32 and an output shaft 33 having an AF coupler 331 with a joint 332 on the tip, and so on, and is arranged inside the camera body 1 on the right-hand side in FIG. 2. The lens-drive mechanism 30 is arranged so that the rotational axis of the output shaft 33 is parallel with the optical axis of the mounted lens barrel (which is attached on the lens mount 5) and the AF coupler 331 penetrates the lens mount 5 to extend the joint 332 outside the surface of the lens mount 5. The details of the lens-drive mechanism 30 will be discussed later.

The controller controls the AF (auto focus) operation, photographing operation, various types of operations based on the operations of operational switches. For example, operations of the AF motor 32 of the lens-drive mechanism 30, such as whether to start/stop rotation, and in which direction to rotate, and so on, are all controlled by the controller.

The AF sensor is a distance-measurement sensor that applies the so called phase difference detecting method. The AF sensor is provided with a CCD sensor, at a position optically identical with the light-receiving surface of the CCD of the imaging unit. The AF sensor outputs a signal regarding the focusing state inside a predetermined infocus detecting area, which is defined within the image photographing area (not shown), to the controller as an AF video signal. The controller calculates the defocus amount based on the AF video signals and calculates a lens drive direction and the amount of drive for the AF lens or the focusing lens (not shown) to be moved to a position where light rays made incident to the AF lens form an infocus image on an image focusing screen (not shown) based on the defocus amount and the specific lens data of the photographing lens of the lens barrel mounted on the lens mount 5, and then drives the AF motor 32 (AF drive operation). The driving force of the AF motor 32 is transmitted to a gear unit (not shown) through the joint 332, which extends out from the surface of the lens mount 5 of the camera body 1, and a joint provided on a mount of the lens barrel, so that the AF lens is driven or moved in an optical axis direction.

Next, the lens drive mechanism 30 (the AF lens-drive block) will be explained.

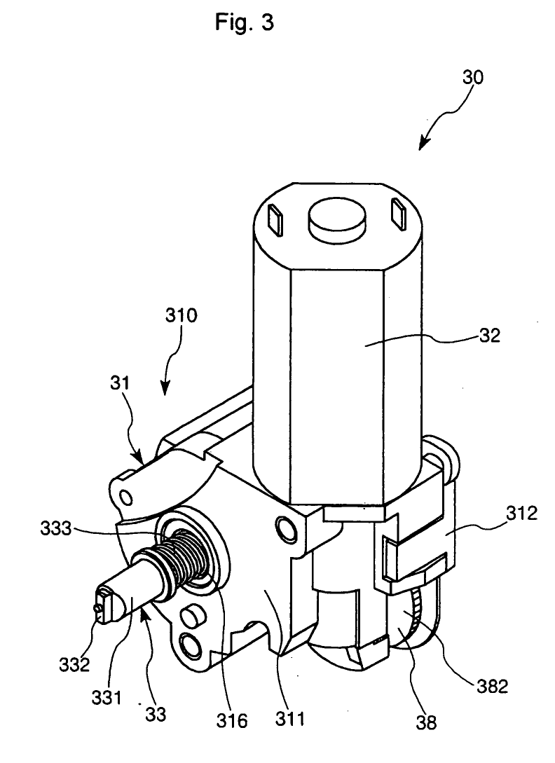

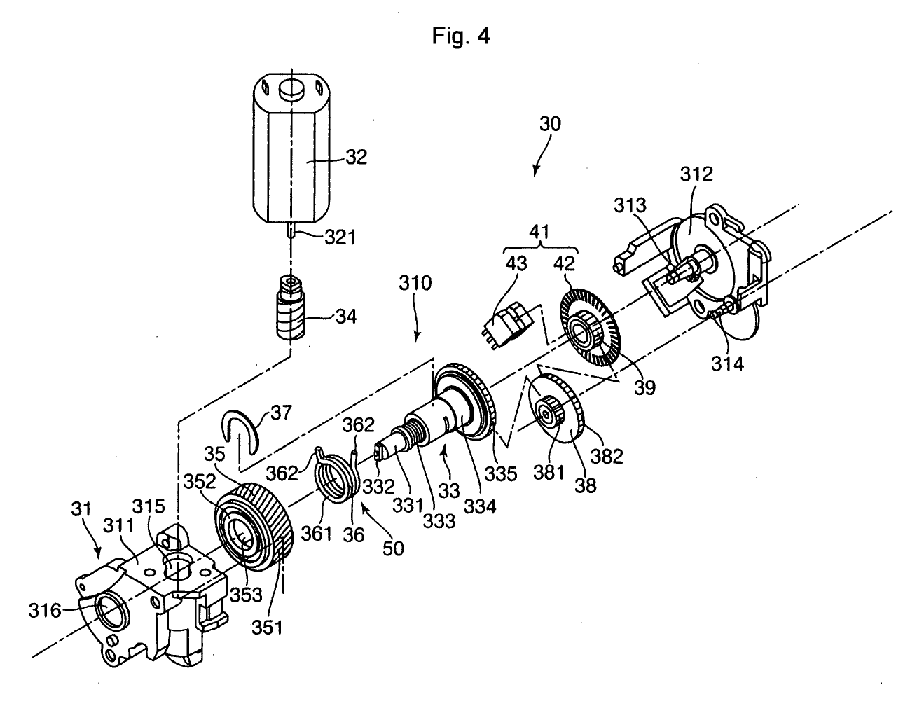

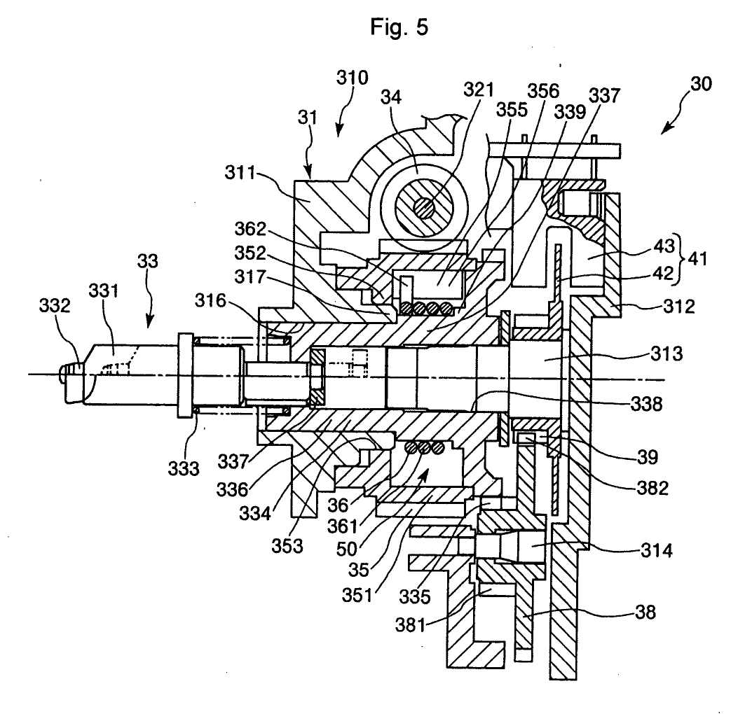

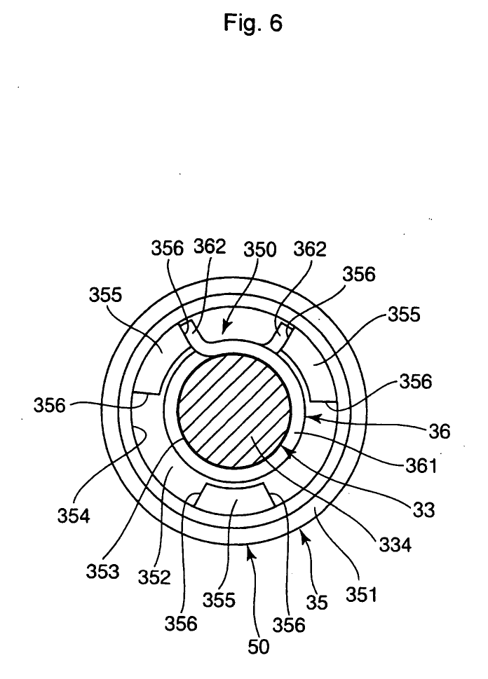

FIG. 3 is a perspective view of the lens drive mechanism of the present embodiment of the invention. FIG. 4 is an exploded perspective view of the lens drive mechanism of the present embodiment. FIG. 5 is a sectional view of the lens drive mechanism of the present embodiment. Further, FIG. 6 is a rear view that illustrates arrangement of an assembly including a worm wheel 35 and a clutch spring 36, where components other than the worm wheel 35 and the clutch spring 36 are removed so as to make the arrangement clearly understood.

In FIG. 5, the sectional view (partly including outer profiles) above the centerline (indicated by a broken line) and the sectional view below the centerline show different sections having different angles of view. Further, in FIG. 5, a retaining ring 37 is not shown. Furthermore, the output shaft 33 is represented by a hatched portion, in FIG. 6, so as to indicate the relationship of the output shaft 33 to the other components.

As shown in the figures, the lens drive mechanism 30 is comprised of a body 310 of which the peripheral part is formed by a casing 31, and the AF motor (the driving source) 32. The casing 31 includes a front casing area 311 and a rear casing area 312. The AF motor 32 is fixed to the outside of the casing 31 with a rotational shaft 321 inserted inside the casing 31 through a hole 315 formed in the front casing area 311.

In FIG. 2, the AF motor 32 is arranged on the right hand side with the rotational shaft 321 aligned in the vertical direction. Namely, the AF motor 32 is arranged so that the rotational shaft 321 is perpendicular to the rotating axis of the output shaft 33 (which will be discussed later) or the rotational shaft 321 is perpendicular to the optical axis of the lens barrel mounted on the lens mount 5.

Thereby, the dimensions of the lens drive mechanism 30 in the direction of the rotating axis of the output shaft 33 can be reduced compared to the configuration where the rotational shaft 321 of the AF motor 32 is arranged in parallel to the rotating axis of the output shaft 33. Therefore, this configuration is very effective for a digital camera of which the length extending forward from a shutter unit is comparatively short.

Further, inside the casing 31 of the body 310, the output shaft 33, the worm wheel (a ring member) 35 which is inserted into the output shaft 33 via the clutch spring (a torsion coil spring) 36, a worm gear 34 which engages the worm wheel 35, the retaining ring 37 (the retaining spring 37 can be reduced), a double gear wheel 38, and an encoder (detecting device) 41, are provided. Note that, an elastic coupling member is composed of the clutch spring 36.

The output shaft 33 includes the AF coupler 331, on which the joint 332 is formed on the tip and engages with the joint provided on the lens barrel attached to the camera body 1, coil spring (biasing member) 333, a retainer 334 generally having a cylindrical outline, and a gear wheel 335 provide on the rear end of the retainer 334. The fore end of the AF coupler 331 (left hand side in FIGS. 3 and 4) extends out from the casing 31 through the hole 316 formed on the front casing 311. The fore end side of the retainer 334 of the output shaft 33 is formed as a small diameter section 336 having a diameter smaller than the diameter of the base end side, and a small diameter section 336 is inserted into the hole 316 of the front casing 311. Further, a play between the outer surface of the small diameter section 336 and the inner surface of the hole 316 of the front casing 311 is made small and is filled with lubricant, so that the output shaft 33 is rotated smoothly.

The coil spring 333 is a little compressed and interposed between the AF coupler 331 and the retainer 334. The AF coupler 331 is suitably biased by the coil spring 333 in a direction that separates the joint 332 from the retainer 334. The base end of the AF coupler 331, which is opposite to the joint 332, is movable along the axis of the output shaft 33, relatively against the retainer 334, due to the coil spring 333. Further, a ring 337 is fixed to the base end of the AF coupler 331, so that the AF coupler 331 is retained so as not to separate from the retainer 334 when the joint 332 is separated from the retainer 334 by the maximum amount (an extended position). Note that, the AF coupler 331 and the retainer 334 are engaged at the base end of the AF coupler 331, and the relative rotation between the AF coupler 331 and the retainer 334 is restricted, but allowing integrated rotation.

As described above, the AF coupler 331 is suitably biased in the direction which separates the AF coupler 331 from the retainer 334 by the biasing force of the coil spring 333. When the lens barrel is not attached to the lens mount 5, the AF coupler 331 is in the extended position. On the other hand, when attaching a non AF lens barrel, a different type of AF lens barrel that is not able to engage with the joint 332 of the AF coupler 331 (such as a lens barrel provided by another maker), or a lens barrel that engages with the joint 332 of the AF coupler 331, to the lens mount 5, the AF coupler 331 is pressed and moved backward, so that the AF coupler 331 is retracted inside the surface of the lens mount 5.

Further, shafts 313 and 314 are provided inside the rear casing 312, and both the shafts 313 and 314 are parallel with each other. A hole 338 having a circular section is formed on the retainer 334 of the output shaft 33 along axis of the output shaft 33. The base end side (right hand side in FIGS. 3-5) of the retainer 334 of the output shaft 33 is inserted into the shaft 313 and is rotatably supported by the shaft 313. Further, play between the outer surface of the shaft 313 and the inner surface of the hole 338 of the retainer 334 is made small and is filled with lubricant, so that the output shaft 33 is rotated smoothly.

Further, the output shaft 33 penetrates the worm wheel 35. The worm wheel 35 is positioned at the base end of the retainer 334 of the output shaft 33, and movement along the rotational axis of the output shaft 33 is restricted by the retaining ring 37 attached or fixed on the retainer 334.

Inside the worm wheel 35, there is provided a torque limiter mechanism (clutch mechanism) 50, which limits the output torque of the output shaft 33, so that rotational force (rotational motion) of the worm wheel 35 is transmitted to the output shaft 33 through the torque limiter mechanism 50.

Namely, when the AF motor 32 is driven and thus the rotational shaft 321 is rotated in a predetermined direction, the drive force (rotational force) is transmitted to the output shaft 33 via the worm gear 34, worm wheel 35, and the clutch spring 36, so that the output shaft 33 is rotated in the predetermined direction. Further, during the above power transmission, rotational speed of the AF motor 32 is reduced by the worm gear 34 and the worm wheel 35.

Further, when the rotational shaft 321 of the AF motor 32 is rotated in the opposite direction to the above-mentioned direction, the drive force (rotational force) is transmitted to the output shaft 33 via the worm gear 34, worm wheel 35, and the clutch spring 36, so that the output shaft 33 is rotated in the opposite direction to the above predetermined direction.

Therefore, the worm gear 34, the worm wheel 35, and the clutch spring 36 comprise a power transmission system that transmits the drive force (rotational force) of the AF motor 32 to the output shaft 33. Note that, a description of the torque limiter mechanism 50 will be given later.

As described above, since the main part of the power transmission system of the present lens-drive mechanism 30 is configured by the worm gear 34 and worm wheel 35, the drive force of the AF motor 32 can be transmitted to the output shaft 33 while reducing the rotational speed by a large gear ratio compared to a system using normal gear wheels.

The double gear wheel 38 includes a gear wheel 381 and a gear wheel 382 which adjoin and are integrated together coaxially. The gear wheel 381 has a smaller diameter than that of the gear wheel 382 and the gear wheel 335. The double gear 38 is inserted into the shaft 314 and is rotatably supported by the shaft 314.

Further, the encoder 41 comprises the pulser (rotating disk) 42, which rotates together with the output shaft 33, and a photointerrupter 43 having a light emitting device and light detecting device which are disposed face to face. The encoder 41 can detect the rotation of the output shaft 33 (the amount of rotation), i.e. the displacement of the AF lens, by detecting the rotation (the amount of rotation) of the pulser 42 by means of the photointerrupter 43.

The pulser 42 is a circular disk in which slits or notches having a predetermined width are formed along the periphery at a predetermined pitch. The pulser 42 is inserted into the shaft 313 and is rotatably supported by the shaft 313. Further, the pulser 42 is disposed on the backside of the output shaft 33 (the right hand side in FIG. 4). The photointerrupter 43 is arranged so that the peripheral part of the pulser 42 is positioned between the light emitting device and the light-detecting device.

Further, on a disk plane of the pulser 42, a gear wheel 39 is provided that coaxially rotates with the pulser 42 and has a diameter smaller than that of the gear wheel 382. The gear wheel 39 engages with the gear wheel 382 of the double gear wheel 38 and the gear wheel 381 of the double gear wheel 38 engages with the gear wheel 335 of the output shaft 33.

Signals from the photointerrupter 34 (or encoder 41), such as pulse signals (detected signals), are input to the controller and used in the above-discussed AF drive control.

When the AF motor 32 is actuated and thus the output shaft 33 is rotated, the rotational force of the output shaft 33 is transmitted to the pulser 42 through the gear wheels 335, 381, 382, and 39, so that the pulser 42 is rotated. At the same time, the rotational speed of the AF motor 32 is increased by the gear wheels 335, 381, 382, and 39.

Namely, a speed increasing gear train (rotational power transmission mechanism), which increase the rotational speed, is configured from the gear wheels 335, 381, 382, and 39.

As described above, the output shaft 33 and the pulser 42 are not directly connected to the lens-drive mechanism of the present embodiment, and the rotational force (or rotation) is transmitted from the output shaft 33 to the pulser 42 and increases the rotational speed by and through the gear wheels 335, 381, 382, and 39.

Further, the pulser 42 is arranged so that the rotational axis of the pulser 42 is coaxial with the rotational axis of the output shaft 33. Thereby, the pulser 42 can be positioned on the backside (the base end side) of the output shaft 33, so that the dimensions of the lens-drive mechanism 30 in a direction perpendicular to the rotational axis of the output shaft 33 (a radial direction of the pulser 42) can be reduced compared to when the pulser 42 is disposed at the lateral side of the output shaft 33 (when the rotational axis of the pulser 42 is arranged apart from the rotational axis of the output shaft 33). Further, the frontal projected area of the lens-drive mechanism 30 (the projected area onto a plane perpendicular to the rotational axis of the output shaft 33) can be reduced compared to when the rotational axes of the output shaft 33, the double gear 38, and the pulser 42 are arranged at positions corresponding to the vertices of a triangle, that is viewed from the front side of the output shaft 33, that is, in the direction along the rotational axis of the output shaft 33. Further, an exclusive shaft has not been separately provided for the pulser 42, and the shaft 313 of the output shaft 33 is also used as the shaft of the pulser 42 while efficiently using the space between the output shaft 33 and the rear casing 312 where the shaft 313 is provided, so that the size of the camera body 1 can be reduced.

Furthermore, the worm wheel 35 is arranged so that the rotational axis of the worm wheel 35 is coaxial with the rotational axes of the output shaft 33 and the pulser 42. Thereby, the dimensions of the lens-drive mechanism 30 in a direction perpendicular to the rotational axis of the output shaft 33 can be reduced compared to when the worm wheel 35 is disposed at the lateral side of the output shaft 33 (when the rotational axis of the worm wheel 35 is arranged apart from the rotational axis of the output shaft 33), so that the size of the lens-drive mechanism 30 can be further reduced.

Next, the structure of the torque limiter 50 will be explained.

As shown in FIGS. 4 and 6, the torque limiter mechanism 50 is provided inside the worm wheel 35.

Namely, the torque limiter mechanism 50 is comprised of the clutch spring 36 installed inside the worm wheel 35 and a receiving portion 350 which is formed inside the inner periphery of the worm wheel 35 and which receives the clutch spring 36.

The clutch spring 36 includes a squeezing section (ring section) 361, which is coiled around the retainer 334 of the output shaft 33 so as to pinch or squeeze the retainer 334. The clutch spring 36 has a ring shaped profile in a plan view, and a pair of legs 362, which protrude outside both ends of the squeezing section 361 toward a radial direction of the output shaft 33. The clutch spring 36 transmits the rotating force of the worm wheel 35 to the output shaft 33 by squeezing and retaining the retainer 334 of the output shaft 33. Further, the clutch spring 36 releases the rotational force transmitted from the AF motor 32 and rotational force due to the moment of inertia when the torque which affects the output shaft 33 is more than or equal to a predetermined value, such as when the rotation of the AF coupler 331 is forcibly stopped (when the rotation of the output shaft 33 is stopped) as a result of the AF lens inside the lens barrel arriving at either of the end points (limits) for the near side or the far side.

On the other hand, the worm wheel 35 has a peripheral sidewall 351 where teeth are formed on the outer periphery (i.e., the peripheral sidewall 351 functions as a gear), a base plate having a hole 353 to which the output shaft 33 is inserted, and three protuberances 355 which protrude from the inner face 354 of the peripheral sidewall 351 toward the center. The receiving portion 350, which receives the clutch spring 36, is mainly comprised of these protuberances 355. Note that, obviously the number of the protuberances 355 is not limited to three.

Further, both ends or end faces (abut faces) 356 of protuberances 355 in a circular direction of the worm wheel 35 form stop sections that engage or that are engageable with the leg 362 of the clutch spring 36 and are used to limit the position of the legs 362. Thereby, a pair of stop members, which is arranged in a circular direction of the worm wheel 35, and which engage or are engageable with the pair of legs 362 of the clutch spring 36, comprises the end faces 356 of two neighboring protuberances 355 or a pair of end faces 356 which face each other.

The clutch spring 36 is installed inside the inner surface of the peripheral sidewall 351 while the squeezing section 361 pinches or squeezes the retainer 334 of the output shaft 33. Further, the pair of legs 362 is positioned between two oppositely facing end faces 356 of two neighboring protuberances 355 and their positions are fixed by the end faces 356.

Further, the clutch spring 36 is arranged so that the squeezing section 361 is positioned between a ring shaped convex portion 339 (formed on the base end of the retainer 334) and a ring shaped protuberance 317 (formed on the front casing 311). Namely, the protuberance 317 and the convex portion 339 engages with the clutch spring 36 so as to limit the movement of the clutch spring 36 along the axial direction of the output shaft 33, thus the above structure prevents the clutch spring 36 dropping off the retainer 334.

Note that, the clutch spring 36 can be put in a situation where one of or both of the legs 362 do not engage with end faces 356, however, the leg(s) 362 will be engaged with the end face 356 when the lens-drive mechanism 30 is actuated.

Next, a function of the torque limiter mechanism 50 will be explained.

While the AF lens inside the lens barrel, which is attached on the lens mount 5, is driven between the end point for the near side and the end point for the far side, the retainer 334 is normally squeezed and retained by the squeezing section 361 of the clutch spring 36, so that slip between the squeezing section 361 (worm wheel 35) and the output shaft 33 is prevented. Namely, output shaft 33 is connected to the worm wheel 35 through the clutch spring 36, thus rotating with the worm wheel 35. Thereby, the rotational force of the AF motor 32 is securely transmitted to the output shaft 33.

On the other hand, when force (torque) from the lens barrel side that affects on the output shaft 33 surpasses a predetermined value and the rotational speed (or the number of revolution) of the output shaft 33 decreases or ceases, an end face 356 of a protuberance 355 inside the worm wheel 35 abuts against a leg 362 of the clutch spring 36, which is on the trailing side of the rotation, so that the trailing leg 362 is urged to the rotational direction and the space between two legs 362 is diminished. As a result, the squeezing section 361 of the clutch spring 36 is expanded (i.e., the diameter of the squeezing section 361 is increased) and the squeezing section 361 (worm wheel 35) starts to slip on the output shaft 33, so that the rotational force transmission from the worm wheel 35 to the output shaft 33 is decreased or stopped.

For example, when the AF lens inside the lens barrel reaches either of the end points for the near side or the far side, that is, when the drive member of the AF lens inside the lens barrel reaches a limit of the drivable range, a load (in the direction opposite to the rotation of the lens-drive mechanism 30) acts on the output shaft 33 from the lens barrel side and rotation of the AF coupler 331 (output shaft 33) is forcedly stopped, so that the rotation of the squeezing section 361 of the clutch spring 36 is stopped.

On the other hand, the AF motor 32 continues to rotate, so that the rotation of the worm wheel 35 is continued. Thereby, a leg 362 of the clutch spring 36, which is on the trailing side of the rotation, engages with an end face 356 of the protuberance 355 of the worm wheel 35 and is urged in the rotational direction by the end face 356 and rotated with the worm wheel 35, while the other leg 362 of the clutch spring 36, which is on the leading side of the rotation, stops rotation with the squeezing section 361. Namely, the space between two legs 362 decreases and the squeezing section 361 of the clutch spring 36 is expanded (i.e., the diameter of the squeezing section 361 is extended), and thereby the squeezing section 361 (worm wheel 35) starts to slip on the output shaft 33, so that the output shaft 33 and the clutch spring 36 no longer rotate together with each other. Namely, although the AF motor 32 continue to rotate, only the worm wheel 35 and the clutch spring 36 are rotated, and the rotational force is not transmitted to the output shaft 33 or only a little bit of the rotational force is transmitted to the output shaft 33 (i.e., the most of the rotational force can be released).

Accordingly, damage to or destruction of each components, such as the worm gear 34, the worm wheel 35, the gear wheels 335, 381, 382, and 39 of the lens-drive mechanism 30, the AF lens, the AF lens drive member, and the gear unit inside the lens barrel, can be prevented while the AF drive operation is being carried out.

As described above, according to the lens-drive mechanism 30 of the present embodiment, the size of the lens-drive mechanism 30 can be reduced, because the pulser 42 is arranged so that the rotational axis of the pulser 42 is coaxial with the rotational axis of the output shaft 33. Particularly, the dimension of the lens-drive mechanism 30 in a direction perpendicular to the rotational axis of the output shaft 33 (a radial direction of the pulser 42) can be effectively reduced. Further, the frontal projected area of the lens-drive mechanism 30 (the projected area onto a plane perpendicular to the rotational axis of the output shaft 33) can be reduced. Thereby, the size of the camera body 1 can be reduced.

Further, because of the torque limiter mechanism 50 is provided inside the worm wheel 35, the size of the lens-drive mechanism 30 can be further reduced compared with the structure where the torque limiter mechanism is provided at another place. According to the above structure, the dimensions of the lens-drive mechanism 30 can be reduced in the direction along the rotational axis of the output shaft 33.

Note that, in the present embodiment, three protuberances, each of which having a pair of end faces (stop members) 356, are provided on the worm wheel (ring member) 35, however, in the present invention, the number of pairs of the end faces (stop members) 356 is not limited to three. For example, the number of pair the end faces can also be one.

Further, in the present invention, the clutch spring 36, for example, can also be configured so that the squeezing section 361 is expanded (the diameter of the squeezing section 361 is increased) when the pair of legs 362 is moved to separate from each other. In this case, at least one stop member disposed between the pair of legs 362 will work. Namely, the pair of legs 362 is arranged at both sides of the protuberance 355.

Further, in the present embodiment, although the inventive lens-drive mechanism is applied to a digital camera, application of the lens-drive mechanism is not limited to a digital camera, so that it can also be applied to a film camera and the like.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2004-326564 (filed on Nov. 10, 2004) which is expressly incorporated herein, by reference, in its entirety.

1. A lens-drive mechanism for a camera, comprising:
a drive source;
an output shaft that comprises a joint which is connected to a lens barrel attached to a camera body, and which is rotated by a driving force from said drive source and transmits the rotation to said lens barrel through said joint; and
a detector comprising a rotating disk that rotates together with said output shaft, wherein said detector detects rotation of said output shaft by detecting rotation of said rotating disk;
wherein said rotating disk is arranged so that a rotational axis of said rotating disk substantially coincides with a rotational axis of said output shaft.

2. A lens-drive mechanism according to claim 1, further comprises a power transmission system that transmits drive force of said drive source to said output shaft, wherein said power transmission system comprises a worm gear provided on a rotational axis of said drive source, and a worm wheel that engages said worm gear and in which said output shaft is inserted.

3. A lens-drive mechanism according to claim 2, wherein a torque limiting mechanism is provided inside said worm wheel, said torque limiting mechanism limits torque which is output from said output shaft.

4. A lens-drive mechanism according to claim 3, wherein said torque limiting mechanism is coiled around said output shaft to contact said output shaft, and comprises an elastic connecting member having two ends and both ends protrude outside with respect to said output shaft, and a receiving portion is provided in said worm wheel and receives said connecting member;
wherein said receiving portion is arranged along the periphery of said worm wheel and has a pair of stop members that is engageable with said both ends of said connecting member;
wherein said output shaft is connected to said worm wheel through said connecting member and rotates with said worm wheel; and
wherein transmission of rotation of said output shaft is controlled when said connecting member is expanded and one of said stop members abuts against one of said ends, when rotational speed of said output shaft is reduced or when the rotation of said output shaft is stopped, as a result of a force which is applied to said output shaft from the lens barrel side exceeding a predetermined value.

5. A lens-drive mechanism according to claim 4, wherein said both ends of said connecting member are disposed between said pair of stop members; and
wherein said connecting member is so configured as to expand when said both ends are brought near to each other.

6. A lens-drive mechanism according to claim 4, wherein said connecting member comprises a clutch spring.

7. A lens-drive mechanism according to claim 2, wherein said worm wheel is arranged so that a rotational axis of said worm wheel substantially coincides with said rotational axes of said output shaft and said rotating disk.

8. A lens-drive mechanism according to claim 1, wherein said drive source is arranged so that a rotational axis of the drive source is substantially perpendicular to said rotational axis of said output shaft.

9. A lens-drive mechanism according to claim 1, wherein said output shaft and said rotational disk are not directly connected, and a rotational force from said output shaft is transmitted to said rotational disk through a rotational force transmission mechanism.

10. A lens-drive mechanism according to claim 9, wherein said rotational force transmission mechanism comprises a gear train that increases rotational speed.

11. A lens-drive mechanism according to claim 1, wherein said drive source comprises a motor.
